(19) United States
(12) Patent Application Publication
(10) Pub. No.: US 2001/0037253 A1
(43) Pub. Date: Nov. 1, 2001

(54) Secure format system for carrying out on-line purchasing of products

(76) Inventor: Lanard M. Kensey, Clymer, PA (US)

Correspondence Address: Michael R. Swartz, Esq., 205 Royal Oak Avenue, Pittsburgh, PA, 15235, US

(21) Appl. No.: 09/800,331

(22) Filed: Mar. 6, 2001

Related U.S. Application Data
(60) Provisional application No. 60/187,252, filed on Mar. 6, 2000.

(51) Int. Cl. G06F 17/60

(52) U.S. Cl. 705/26

(57) ABSTRACT

A secure format system for carrying out on-line purchasing of products includes an on-line shopping and customer service portals and merchant and customer members. Each portal and each merchant member website are identified by respective domain names having the same format, such being (prefix)(name).(suffix), and having a (prefix) portion, a (name) portion and a (suffix) portion. The merchant member websites are accessible via the shopping portal and the (prefix) portions of their domain names are the same as the (prefix) portion of the domain names of the shopping portal. The (prefix) portion of the domain name of the on-line customer service portal is the same as the (prefix) portions of the domain names of the shopping portal and merchant member websites. The customer members provide their personal and financial information to the customer service portal and visit the shopping portal on-line in order to go to any of the websites of the merchant members to browse their products and select products to purchase and when completed to cause processing of purchase transactions from each of the merchant members of the particular purchased products to be handled by the customer service portal such that the merchant members only receive shipping address information from the customer service portal of the locations of the customer members for delivery of the purchased products thereto.

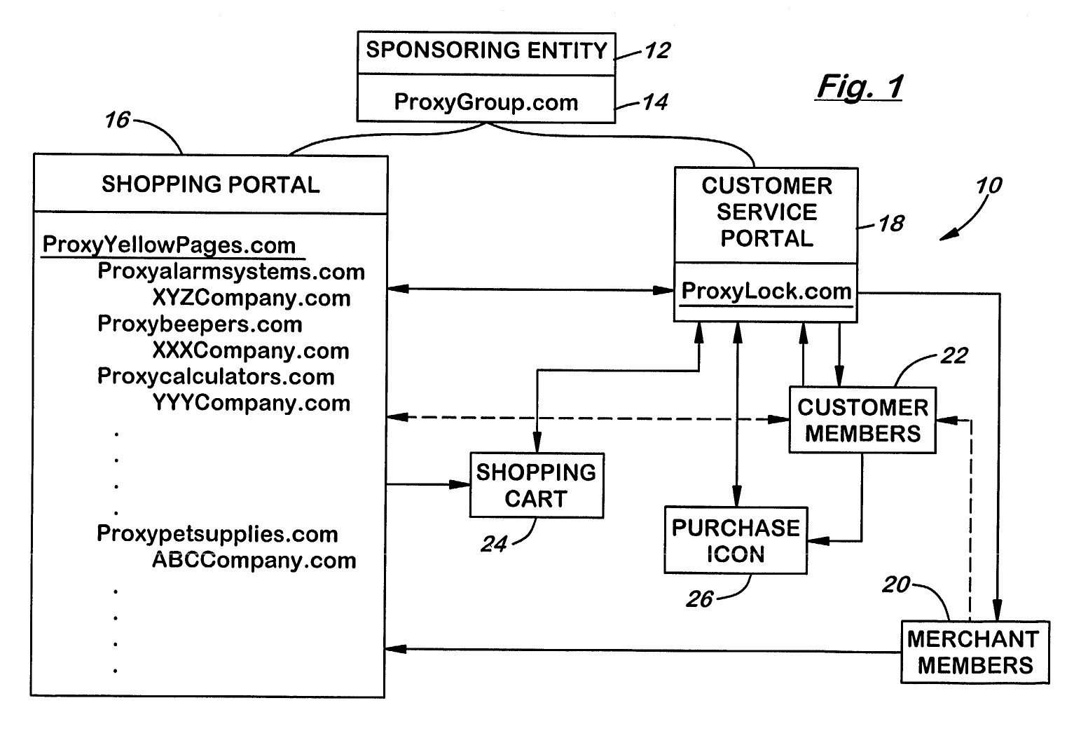

This utility patent application claims the benefit of provisional application No. 60/187,252 filed Mar. 6, 2000.

### BACKGROUND OF THE INVENTION

1. Field of the Invention

The present invention generally relates to on-line purchasing of products and services (for the sake of brevity hereinafter both will be referred to as “products”) and, more particularly, is concerned with a secure format system for carrying out on-line purchasing of products. As used herein, “on-line” means over the Internet, on the World-Wide Web or on other widely usable networks which consumers can readily access and connect with using modems of personal computers or other types of communications devices.

2. Description of the Prior Art

Global e-commerce is a multi-billion dollar marketplace and its pace of growth is increasing yearly. Many products are presently offered for sale on websites on the Internet (or World-Wide Web) and many more are added daily. All kinds of companies now have websites a purchaser can visit to make “on-line” purchases of the various products that are offered.

Normally, a purchaser must log on to the website of a company, select the product(s) desired to be purchased on that website and then supply various personal information and a credit card number to complete the transaction. Once the transaction is completed, the company sponsoring the website ships the purchased product(s) to the address of the purchaser by mail or commercial delivery.

Most companies on their websites only offer a selected group of products and thus the purchaser must contact the websites of many other companies to obtain other types of products. Each time the purchaser contacts the website of a different company the purchaser is requested to supply his or her personal information and credit card number. Should a problem arise with the product(s) purchased, the purchaser must return to the specific website that the product(s) was purchased from. If there are multiple products purchased from multiple websites, the purchaser must return to and deal with each of the websites of the different companies.

There are companies that have various software programs in operation on the Internet that monitor and track purchase activity of individuals and that build profiles of individuals that not only includes purchase activity and habits of those individuals over a period of time, but also includes an extensive collection of personal and/or confidential information gathered by the websites that the individuals contacted and supplied with such information. These profiles, or personal dossiers, are then sold and traded by these companies to others for advertising and solicitation purposes, scattering the personal and confidential information of the individuals to all corners of the world and thereby invading the privacy of each of such individuals.

At the present time, there are no practical safety checks on the invasion of consumers' privacy which is of major concern. The lack of assurance concerning users' privacy and protection while browsing and making purchases on the Internet has greatly limited the potential number of transactions on the Internet and, instead, has created a serious obstacle to future electronic commerce growth. Consumer concern over privacy and security is now the single biggest inhibitor to growth of the Internet. According to a 1998 Business Week survey, privacy was found to be the number one consumer issue facing the Internet, being of more concern than cost, ease of use or spam. It is estimated that 78% of on-line users would increase their use of the Internet and that 61% of non-users would be more likely to begin using the Internet if privacy practices were disclosed and protections were strengthened.

Consequently, there is a need to control and safeguard the spread of personal information of consumers using the Internet.

### SUMMARY OF THE INVENTION

The present invention provides a secure format system for carrying out on-line purchasing of products which is designed to satisfy the aforementioned need. The present invention provides separate “shopping” and “customer service” website portals identified by domain names having the same format, (prefix)(name).(suffix), and the same (prefix) portion which allows centralization of processing at the customer service portal of transactions entered into by on-line customer members at the shopping portal. The customer members browse and select products by visiting the shopping portal and then pay for the selected products or return previously purchased products by visiting the customer service portal, while doing both in total privacy and security. Effectively addressing customer privacy and security issues is one of the central concerns of the present invention as demonstrated by its guarantee of the products purchased by, and of the privacy and security of, the customer members that utilize the shopping and customer service portals of the secure format system.

Accordingly, the present invention is directed to a secure format system for carrying out on-line purchasing of products, that is, purchasing of products over the Internet. The secure format system comprises: (a) an on-line shopping portal identified by a domain name having the format, (prefix)(name).(suffix), and having a (prefix) portion, a (name) portion and a (suffix) portion; and (b) a merchant membership group including a plurality of merchant members each accessible via a website identified by a domain name having the same format as the shopping portal and also having a (prefix) portion the same as the (prefix) portion of the domain names of the shopping portal and the other merchant members. The websites of the merchant members are only accessible via the on-line shopping portal. The system further comprises: (c) an on-line customer service portal identified by a domain name having the same format as the domain name of the shopping portal and having a (prefix) portion the same as the (prefix) portions of the domain names of the shopping portal and merchant members; and (d) a customer membership group including a plurality of consumers who upon becoming customer members provide personal and financial information to the customer service portal and must visit the shopping portal on-line in order to go to any of the websites of the merchant members to browse their products and select products to purchase and when completed to cause processing of purchase transactions from the websites of the merchant members of the particular purchased products to be handled by the customer service portal such that the merchant members only receive shipping address information from the customer service portal of the locations of the customer members for delivery of the purchased products thereto.

The present invention is also directed to a secure format system for carrying out on-line purchasing of products wherein the system comprises: (a) an on-line shopping portal; (b) a plurality of websites listed and accessible on the shopping portal, each of the websites offering products for sale; and (c) an on-line customer service portal to which customers, intending to patronize the websites of the shopping portal, first provide their personal and financial information needed for processing purchase transactions on the websites such that the customer service portal needs only to receive the personal and financial information of customers one time to process future purchase transactions of customers on any of the websites of the shopping portal. Furthermore, the customer service portal handles all aspect of the purchase transactions by the customers on the websites of the shopping portal from paying for the purchases to dealing with return of defective products or report of unsatisfactory service. The customers must visit the shopping portal on-line in order to go to any of the websites to browse the products and select products to purchase and when completed to cause processing of purchase transactions of the particular purchased products to be handled by the customer service portal. The websites on the shopping portal only receive shipping address information from the customer service portal of the locations of the customers for delivery of the purchased products thereto.

These and other features and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

In the following detailed description, reference will be made to the attached drawings in which:

The single figure is a diagram depicting a secure format system of the present invention for carrying out on-line purchasing of products.

### DETAILED DESCRIPTION OF THE INVENTION

Referring to the drawings and particularly to the single figure, there is illustrated a secure format system of the present invention, generally designated 10, for carrying out on-line purchasing of products. The system 10 of the present invention basically includes an on-line entity 12 having a main primary website 14, for instance identified by the trademark “ProxyGroup.com”, which is subdivided into two subsidiary website portals, one a “shopping” portal 16, for instance identified by the trademark “ProxyYellowPages.com”, and the other a “customer service” portal 18, for instance identified by the trademark “ProxyLock.com”.

Overall, the system 10 operates as follows. Different vendors of products become merchant members 20 of the system 10 and are permitted to adopt a website domain name or address having the same format at the domain name or address of the entity 12, and also of the shopping and customer service portals 16, 18, such format being (prefix)(name).(suffix). The (prefix) portion of the domain names of the websites of the entity 12, shopping and customer service portals 16, 18 and merchant members 20 are the same, preferably being “proxy”, so to identify the e-commerce vendors as ones that have contracted with the on-line entity 12 to be merchant members 20 of the system 10. On-line consumers sign up to become customer members 22 by registering their confidential personal and financial (credit card or debit card) information at the customer service portal 18 (also known as a lock website) of the system 10. Then, at the shopping portal 16, the registered on-line customer members 22 can click on the domain names or addresses of the listed on-line merchant members 20 and browse their products and select which of the products the customer members 22 intend to purchase by putting the products into a shopping cart 24. When their shopping is completed, the on-line customer members 22 click on a purchase icon 26 and all processing for the transactions with the different merchant members 20 of the particular purchased products is then taken care of by the customer service portal 18. The merchant members 20 then mail or otherwise deliver the purchased products to the locations of the customer members 22. The customer service portal 18 is responsible for every aspect of the customer member transactions, from paying the e-commerce merchant members 20 to dealing with return of defective products or report of unsatisfactory service. All information from and concerning the customer members 22 remains secure with the customer service portal 18 and is not distributed to any of the e-commerce merchant members 20.

It should be recognized that a key attribute of the system 10 is the use of a common (prefix) portion, such as “proxy”, in the website domain names or addresses of the merchant members 20. The common (prefix) portion readily permits the entry and processing of all purchase transactions to be efficiently centralized, that is, to be carried out by the customer service portal 18 of the single entity 12 even though the customer members 22 are making purchases with many different merchant members 20 through their different websites listed on the shopping portal 16. Thus, the customer members 22 only give out their personal and financial information once to the customer service portal 18 at the time of sign-up or registration to become part of customer membership within the system 10. This information remains “locked” in the customer service portal 18 as the customer members 22 select the various purchases on the different websites of the merchant members 20 listed on the shopping portal 16. In such manner, the privacies of all customer members 22 are protected in that all confidential personal and financial information of each of the customer members 22 is kept and maintained within and does not leave from the customer service portal 18. Only the shipping address of a customer member 22 making a purchase is released to the respective merchant member 22 with regard to where to send the purchased product. The result of protecting the privacy of customer members' confidential personal and financial information in such manner is that, as they shop, select and purchase products on the various websites of the merchant members 20 listed on the shopping portal 16, all customer members 22 are anonymous to the merchant members 20.

The shopping portal 16, or the one website of the entity 12 identified by the trademark“ProxyYellowPages.com”, comprises a large number, such as from one to two thousand, of specialized and selected vendors that offer at least one or more products under a generic product type identified by the (name) portion of the domain name, such as found in the Yellow Pages, but with the common (prefix) portion, “Proxy”, of the domain name before the generic (name) portion. By adding the common (prefix) portion to registered .com domain names, the present invention developes a new area in the crowded .com marketplace. Thus, by reserving from one to two thousand (prefix)(name).com website addresses or domain names, the entity 12 has created an island of high quality e-commerce websites in the vast sea of the Internet. Examples of (prefix)(name).com domain names are Proxyalarmsystems.com, Proxybeepers.com, Proxybookcases.com, . . . , Proxycalculators.com, Proxypetsupplies.com, etc. Under Proxyalarmsystems.com there is a merchant member website that sells alarm systems, such as XYZCompany.com. Under the Proxypetsupplies.com there is a merchant member website that sells pet supplies. Each of these from one to two thousand proxy(name).com domain names is registered by the entity 12 annually and then licensed to selected merchant members 20.

The merchant members 20 can be selected in various ways, one of which is as follows. The entity 12 has an auction website that places all the registered websites addresses or (prefix)(name).com domain names that will be listed on the shopping portal 16 up for auction to the highest bidder. As mentioned above, there can be from one to two thousand of such domain names although other numbers of such domain names are possible. The prospective bidder or bidders for any given proxy(name).com website address or domain name requests a copy of a prospectus from the auction website of the entity 12. The interested prospective vendors fill out the request form, pay the fee and submit them back to the entity 12. After being qualified by the entity 12, each of the vendors is given a password and identification number which gives each vendor the opportunity, within a specified time period, to place a bid on a given proxy(name).com website domain name to be listed on the shopping portal 16 of the entity 12. The highest bidder is then selected by the entity 12 for a given proxy(name).com website address. In exchange for the selected bid, the vendor is granted a license agreement for one year and renewable annually thereafter for a fee that is determined by gross sales of the given website. Also, each successful bidder agrees to abide by predetermined rules and guidelines contained in or annexed to the license agreement. The breach of the same would terminate the license agreement. Further, for a vendor to be qualified for a given type of business of the proxy(name).com website address, at least 60-80% of the vendor's business must be involved in that type of business, in this embodiment of the present invention the type of business being given by the (name) portion of the website domain name.

Any consumer can become a customer member 22 of the customer service portal 18. Memberships preferably, although not necessarily, are of two basic types. The first type is a fee-based membership. The second type is a non-fee-based membership.

For the fee-based membership, the customer member 22 pays an annual membership fee, such as one within the range of from about $20 to $40 annually. In such membership arrangement, all personal and financial information of the customer member 22 conveyed to the entity 12 is maintained by the customer service, or “lock”, portal 18 in confidence with only the shipping address of the customer member 22, in response to making a purchase, being given out to the merchant member 20 listed as a vendor on the shopping portal 16.

For the non-fee-based membership, the customer member 22 pays no annual fee for membership and so general information about the customer member 22 can be collected and distributed to the merchant members 20 listed as vendors on the shopping portal 16. It is anticipated that revenue from advertising would cover the cost of services provided to the second-type non-fee-based customer members 22.

After a consumer has initially signed up with the entity 12 and becomes a customer member 22, he or she is given a membership number. The customer member 22 can then go to the shopping portal 16 which has a list of the proxy(name).com website addresses of all preselected and qualified merchant (or vendor) members 20 offering products from A to Z, similar to the yellow pages of the telephone book. The customer members 22 may browse any of these websites as desired and purchase as many different products from the different websites as desired. At each merchant member website, the customer member 22 merely selects the products to be purchased by the customer member 22 capturing the products in his or her shopping cart 24. The customer member 22 then goes to another merchant member website to repeat the same product selection and purchase steps. When shopping is completed, the customer member 22 then clicks on the purchase icon 26 and just waits for the various purchased products to be shipped to the customer member's address.

In exchange for both types of memberships, the entity 12 through its shopping portal 16 provides the customer members 22 with a listing of the proxy(name).com domain names or addresses of the merchant member websites that the customer member 22 can go to via the shopping portal 16, browse and purchase products on the merchant member websites while maintaining their anonymity and privacy. Also, the entity 12 through its customer service portal 18 handles all aspects of the purchase transactions of the customer members 22, causes the merchant members 20 to ship the purchased products to the customer members 22, and sends each customer member 22 on a periodic basis, preferably monthly, a statement of the transactions and charges that have occurred. Customer members 22 have the option to use their debit cards, credit cards, bank transfer or credit available from the entity 12 to make their purchases.

Additionally, the entity 12 through its customer service portal 18 guarantees the products purchased by the customer members 22 from any of the listed proxy(name).com merchant member websites and any returns, defects, warranties, shipping dates, etc., issues that a customer member 22 has with respect to any product purchased is handled by the customer service portal 18 of the entity 12. Should customer members 22 have any questions regarding orders, they only have to contact the customer service portal 18 rather than the various merchant members 20 from whom the products in question were purchased.

When a customer member 22 purchases a product on the shopping portal 16 of the system 10, the transaction is automatically routed to the customer service portal 18 of the system 10 for handling and, given the software used by the entity 12, there is no chance that confidential personal and financial information of any customer member 22 can be intercepted since such information is not transmitted on-line after each transaction. The confidential personal and financial information of a customer member 22 stays locked up on the customer service portal 18 of the entity 12. Only the shipping address of the customer member 22 is provided to the merchant member 20 and thus the customer members 22 need not worry that their confidential personal and financial information is being spread out over the Internet. Also, as mentioned previously, the system 10 allows the customer members 22 to browse on-line via the shopping portal 16 of the entity 12 in total privacy and anonymity with no information being collected on them or about them.

It should be understood that the present invention is not limited to the specific embodiment described above but is broader in its application. The usage of a (prefix)(name).com format could be applied to diverse subject matters other than just types of businesses of vendors. For example, the (name) portion could be applied to the names of the different fifty states and/or to various foreign countries in a like manner. As applied to any of the states, such as, (prefix)(ohio).com, etc., there could be information about travel, camping, activities and various news pertaining to that particular state, and then advertisements from interested hotels, restaurants, parks, etc., would also be provided. The states would then analogous to merchant members 20 in the system 10.

The logo and theme of the system 10 would be the same in all applications which would enhance the commonality and value of the (prefix) portion of the domain name. When the prefix is applied to foreign countries, the same type of information about the country along with the logo and theme can be applied to that particular country as in the example discussed above concerning the different fifty states. Furthermore, with respect to the foreign country application, the particular country's language would be used, in addition to English; however, in the use of the (prefix)(name).com situations, any language or multiple languages can be used.

Also, a (suffix) portion different from “com”, such as “net” might be used to provide a country specific pointing mechanism. The proxy(name).com domain names would have one merchant member 20 that fills each of these. The proxy(name).net domain names would have a merchant member from each different country. How this would work is that currently when a person from a specific country logs on the Internet there is identifying information that specifies which country that person is located in. That country-identifying information can be used by the system 10 to specify that the merchant member 20 from the particular country is then brought up on the shopping portal 16. For example, a customer member 22 from Germany types in Proxypets.net, a pets merchant member 20 from Germany is displayed on the shopping portal I 6. If a customer member 22 from Spain types in Proxypets.net, a merchant member 20 from Spain is displayed. If there is not a merchant member 20 available from the specific country, then the merchant member 20 that maintains the license for the website, Proxypets.com would come up on the shopping portal 16. The net (suffix) portion would be used for specific domain names, such as Proxypets.net, Proxygroceries.net, Proxypizzadelivery.net, etc., where there is a local need for those products.

Further, although the (prefix) portion, “proxy”, is employed in the exemplary embodiment described hereinabove, it should be understood that other suitable prefixes could be used to accomplish the same objectives of the present invention.

From the foregoing description, it can be readily understood that the features of the system 10 of the present invention, which can be applied together in different combinations to address different situations, are as follows; (1) an on-line shopping portal identified by a domain name having the format, (prefix)(name).(suffix), and having a (prefix) portion, a (name) portion and a (suffix) portion, (2) a merchant membership group including a plurality of merchant members each accessible via a website identified by a domain name having the same format as the shopping portal and also having a (prefix) portion the same as the (prefix) portion of the domain names of the shopping portal and the other merchant members, (3) an on-line customer service portal identified by a domain name having the same format as the domain name of the shopping portal and having a (prefix) portion the same as the (prefix) portions of the domain names of the shopping portal and the merchant members, and (4) a customer membership group including a plurality of consumers who upon becoming customer members provide their personal and financial information to the customer service portal and visit the shopping portal on-line in order to go to any of the websites of the merchant members to browse their products and select products to purchase and when completed cause processing of purchase transactions from each of the merchant members to be handled by the customer service portal such that the merchant members only receive shipping address information from the customer service portal of the locations of the customer members for delivery of the purchased products thereto. As used herein, a website “domain name” is meant to be the same as a website “address”.

It is thought that the present invention and its advantages will be understood from the foregoing description and it will be apparent that various changes may be made thereto without departing from the spirit and scope of the invention or sacrificing all of its material advantages, the form hereinbefore described being merely preferred or exemplary embodiment thereof.

I claim:

1. A secure format system for carrying out on-line purchasing of products, said system comprising:
(a) an on-line shopping portal identified by a domain name having the format, (prefix)(name).(suffix), and having a (prefix) portion, a (name) portion and a (suffix) portion; and
(b) a merchant membership group including a plurality of merchant members each accessible via a website identified by a domain name having the same format as said shopping portal and also having a (prefix) portion the same as the (prefix) portion of the domain names of said shopping portal and other merchant members.

2. The system as recited in claim 1, wherein said domain name of said website of each of said merchant members also has a (name) portion different from the (name) portions of said domain names of said shopping portal and other merchant members.

3. The system as recited in claim 2, wherein said (name) portions of said domain names of said merchant members are related to different types of product being offered for sale on-line by said merchant members at said websites thereof.

4. The system as recited in claim 1, wherein said domain names of said websites of said merchant members are listed on and accessible from said on-line shopping portal.

5. The system as recited in claim 1, wherein said domain name of said website of each of said merchant members also has a (suffix) portion the same as the (suffix) portion of the domain names of said shopping portal and other merchant members.

6. The system as recited in claim 2, further comprising:
(c) an on-line customer service portal identified by a domain name having the same format as said domain name of said shopping portal and having a (prefix) portion the same as the (prefix) portions of said domain names of said shopping portal and merchant members.

7. The system as recited in claim 6, wherein said domain name of said customer service portal has a (name) portion different from the (name) portion of said domain names of said shopping portal and merchant members.

8. The system as recited in claim 6, wherein said domain name of said customer service portal has a (name) portion related to the functions performed by said customer service portal.

9. The system as recited in claim 6, further comprising:
(d) a customer membership group including a plurality of consumers who upon becoming customer members provide their personal and financial information to said customer service portal.

10. The system as recited in claim 9, wherein said customer members must visit said shopping portal on-line in order to go to any of said websites of said merchant members to browse said products of said merchant members and select products to purchase and when completed to cause processing of purchase transactions of the particular purchased products to be handled by said customer service portal.

11. The system as recited in claim 10, wherein said customer members select products to purchase by putting the products into a shopping cart.

12. The system as recited in claim 11, wherein said customer members click on a purchase icon to indicate completion of the purchase of products and, in turn, cause said customer service portal to process the transactions.

13. The system as recited in claim 10, wherein said merchant members only receive shipping address information from said customer service portal of the locations of said customer members for delivery of said purchased products thereto.

14. The system as recited in claim 10, wherein said customer service portal handles every aspect of said purchase transactions of said customer members from paying said merchant members to dealing with return of defective products or report of unsatisfactory service.

15. A secure format system for carrying out on-line purchasing of products, said system comprising:
(a) an on-line shopping portal identified by a domain name having the format, (prefix)(name).(suffix), and having a (prefix) portion, a (name) portion and a (suffix) portion;
(b) a plurality of websites accessible on said shopping portal and each identified by a domain name having the same format as said shopping portal and also having a (prefix) portion the same as the (prefix) portion of the domain names of said shopping portal and the other websites; and
(c) an on-line customer service portal identified by a domain name having the same format as said domain name of said shopping portal and having a (prefix) portion the same as the (prefix) portions of said domain names of said shopping portal and said websites thereon.

16. The system as recited in claim 15, wherein said domain name of each of said websites also has a (name) portion different from the (name) portions of said domain names of said shopping portal and the other websites.

17. The system as recited in claim 16, wherein said (name) portions of said domain names of said websites are related to different types of product being offered for sale on-line on said websites.

18. The system as recited in claim 15, wherein said domain names of said websites are listed on and accessible from said on-line shopping portal.

19. The system as recited in claim 15, wherein said domain name of each of said websites also has a (suffix) portion the same as the (suffix) portion of the domain names of said shopping portal and the other websites.

20. The system as recited in claim 15, wherein said domain name of said customer service portal has a (name) portion different from the (name) portion of said domain names of said shopping portal and said websites.

21. The system as recited in claim 15, wherein said domain name of said customer service portal has a (name) portion related to the functions performed by said customer service portal.

22. The system as recited in claim 15, further comprising:
(d) a customer membership group including a plurality of consumers who upon becoming customer members provide their personal and financial information to said customer service portal.

23. The system as recited in claim 22, wherein said customer members visit said shopping portal on-line in order to go to any of said websites to browse said products and select products to purchase and when completed to cause processing of purchase transactions of the particular purchased products to be handled by said customer service portal.

24. The system as recited in claim 23, wherein said customer members select products to purchase by putting the products into a shopping cart.

25. The system as recited in claim 24, wherein said customer members click on a purchase icon to indicate completion of the purchase of products and, in turn, cause said customer service portal to process the transactions.

26. The system as recited in claim 23, wherein said websites only receive shipping address information from said customer service portal of the locations of said customer members for delivery of said purchased products thereto.

27. The system as recited in claim 23, wherein said customer service portal handles every aspect of said purchase transactions of said customer members from paying for said purchased products to dealing with return of defective products or report of unsatisfactory service.

28. A secure format system for carrying out on-line purchasing of products, said system comprising:
(a) an on-line shopping portal identified by a domain name having the format, (prefix)(name).(suffix), and having a (prefix) portion, a (name) portion and a (suffix) portion;
(b) a merchant membership group including a plurality of merchant members each accessible via a website identified by a domain name having the same format as said shopping portal and having a (prefix) portion the same as the (prefix) portion of the domain names of said shopping portal and the other merchant members, said domain names of said website of each of said merchant members also having a (name) portion different from the (name) portions of said domain names of said shopping portal and the other merchant members, said (name) portions of said domain names of said merchant members being related to different types of product being offered for sale on-line by said merchant members at said websites thereof, said domain names of said websites of each of said merchant members being listed on and accessible from said on-line shopping portal;
(c) an on-line customer service portal identified by a domain name having the same format as said domain name of said shopping portal and having a (prefix) portion the same as the (prefix) portion of said domain names of said shopping portal and said merchant members, said domain name of said customer service portal having a (name) portion different from the (name) portion of said domain names of said shopping portal and said merchant members, said (name) portion of said domain name of said customer service portal being related to the functions performed by said customer service portal; and
(d) a customer membership group including a plurality of consumers who upon becoming customer members of said group provide their personal and financial information to said customer service portal and visit said shopping portal on-line in order to go to any of said websites of said merchant members to browse said products of said merchant members and select products to purchase and when completed to cause processing of purchase transactions of the particular purchased products to be handled by said customer service portal and said merchant members receiving only shipping information from said customer service portal of the location of said customer member for delivery of said purchased products.

29. A secure format system for carrying out on-line purchasing of products, said system comprising:
(a) an on-line shopping portal;
(b) a plurality of websites accessible on said shopping portal, each of said websites offering products for sale; and
(c) an on-line customer service portal to which customers, intending to patronize said websites of said shopping portal, first provide their personal and financial information needed for processing purchase transactions on said websites such that said customer service portal needs only to receive the personal and financial information of customers one time to process future purchase transactions of customers on any of said websites of said shopping portal.

30. The system as recited in claim 29, wherein the products offered for sale on each website are substantially different from products offered for sale on the other websites.

31. The system as recited in claim 29, wherein said customer service portal handles all aspect of said purchase transactions by the customers on said websites of said shopping portal, from paying for said purchases to dealing with return of defective products or report of unsatisfactory service.

32. The system as recited in claim 29, wherein said customers must visit said shopping portal on-line in order to go to any of said websites to browse said products and select products to purchase and when completed to cause processing of purchase transactions of the particular purchased products to be handled by said customer service portal.

33. The system as recited in claim 32, wherein said customer select products to purchase by putting the products into a shopping cart.

34. The system as recited in claim 33, wherein said customers click on a purchase icon to indicate completion of the purchase of products and, in turn, cause said customer service portal to process the transactions.

35. The system as recited in claim 29, wherein said websites only receive shipping address information from said customer service portal of the locations of said customers for delivery of said purchased products thereto.
